(19) United States
(12) Patent Application Publication
(10) Pub. No.: US 2021/0182962 A1
(43) Pub. Date: Jun. 17, 2021

(54) Device for Trading Personal Data

(71) Applicant: Chu-Pin Lin, Taipei (TW)

(72) Inventor: Chu-Pin Lin, Taipei (TW)

(21) Appl. No.: 16/932,915

(22) Filed: Jul. 20, 2020

(30) Foreign Application Priority Data
Dec. 11, 2019 (TW) 108216551

(51) Int. Cl. G06Q 40/04; G06Q 30/02

(52) U.S. Cl. CPC G06Q 40/04; G06Q 30/0201

(57) ABSTRACT

A device is provided for trading personal data (PD). The PD of a data supplier are transferred to a trading platform. A data purchaser pays a required fee to obtain the PD through a communication unit. Thus, the data purchaser can make polls, market researches, and studies. The trading platform helps buyers and sellers in matchmaking PD demands and supplies. A mechanism is built for the data providers to voluntarily distribute PD for earning profits. The device transfers an analysis result of the PD back to the data provider, and, when the device earns profit, share the profit back to the data provider. Hence, the PD can be managed just like personal assets for trading with contribution to market activities. The present invention helps accumulating multivariate data uses and configurations for releasing the true value of big data as promoting the revolution and progress of social policies and industries.

### TECHNICAL FIELD OF THE INVENTION

The present invention relates to trading with big data; more particularly, to trading personal data (PD).

### DESCRIPTION OF THE RELATED ARTS

Financial Technologies are noted in current financial markets, whose core development areas include four ‘ABCD’ pillars—Artificial Intelligence (AI), Block Chain, Cloud Computing, and Big Data. Therein, ‘A’ and ‘D’ involve a lot of the acquiring and using of PD. On facing the strict PD protection law, the global countries which are advanced in information comply with the trend in commodity markets of big data and the business profit models of their derivatives, yet there is still no big data large enough for analysis on the development of future AI platform and, thus, for the production of a variety of big-data goods more humanized.

Regarding regulations related to PD, the presumption is a small amount of data collected, or obtained in a face-to-face way, at early age. The legislators can not predict in advance the coming of big data, nor social networking sites, like Google and Facebook. Applying old concepts to a new world will naturally cause a lot of problems. The PD regulations have already faced difficulties on applying to the small amount of data, not to mention the collection, processing and utilization in the era of big data.

The producing methods of available big data commodities are mostly based on a great amount of historical trading data accumulated by enterprise operators. On the technical level, the basic according assumptions of conventional big-data commodity trades and the developed technologies sprung from the basic assumptions are obtained mostly from the consumer transaction data (I.e. microdata) of operating activities collected one by one by the enterprise operators to be further brought together to form database with its applications—which has become an attended object and a research target. But, a single amount of microdata has a niche too weak to be treated as a commodity element, almost of no commercial value. Under this innate adverse condition, a single consumer can not use the microdata for trading and enter into the commodity markets of big data. Unless the big-data user feeds back actively, profit by no means can be earned from the microdata he owned. Hence, single consumers are essentially ruled out from the traders in the existing big-data commodity trading markets.

In addition, for consideration of rights on using the data in existing database with conventional technologies, the rights of the enterprise operators, i.e. data owners, are mostly concerned only. In the era of big data, the respect on strengthening personal rights of the users is the trend of the time. The PD protection law can only be used when consumers' PD is illicitly used with a result of interest aggrieved, and passively provide a relief channel afterwards. The concrete economic benefit of enjoying the earned profits from PD is not offered to the consumers. Hence, the prior arts do not fulfill all users' requests on actual use.

### SUMMARY OF THE INVENTION

The main purpose of the present invention is to not only establish a trading platform to help purchasers and suppliers in matchmaking PD demands and supplies, but also build an analysis and profit-sharing mechanism for the data providers to voluntarily distribute PD to earn profit, where a device transfers an analysis result of the PD back to the data provider, and, when profit is earned with the device, the profit is further shared back to the data provider through the device; the PD can be managed just like personal assets for trading in markets of PD supplies and demands with contribution to market activities; and the present invention helps accumulating uses and configurations of multivariate data for releasing the true value of big data as effectively promoting the revolution and progress of social policies and industries.

To achieve the above purpose, the present invention is a device for trading PD, which trades PD by using a plurality of networking devices comprising at least one supplier device provided to at least one data supplier and at least one purchaser device provided to at least one data purchaser and comprises a communication unit, a storage unit, a trading platform, an analysis unit, and a profit-sharing unit, where the communication unit communicates to the at least one data purchaser through the at least one purchaser device to respond to at least one PD request uploaded by the at least one data purchaser; and the communication unit communicates to the at least one data supplier through the at least one supplier device to receive at lease one PD uploaded by the at least one data supplier based on the at least one PD request; the storage unit connects to the communication unit to store the at lease one PD received from the communication unit; the trading platform connects to the communication unit and the storage unit; the trading platform matches up the at least one PD request uploaded by the at least one data purchaser with the at least one PD stored in the storage unit so as to obtain a matched trading result to be returned back to the at least one data purchaser; on processing the PD trading activity on the trading platform by the at least one data purchaser, total trading cash-flow data are obtained; and the total trading cash-flow data comprise at least one turnover, at least one profit, and at least one member identification (ID) of the at least one data purchaser related to the PD trading activity; the analysis unit connects to the trading platform; status data of the at least one data supplier are obtained by analyzing the PD to be returned back to the data supplier; the profit-sharing unit connects to the trading platform; and, on processing the PD trading activity to earn a profit through the trading platform based on a predetermined profit-sharing scheme, the total trading cash-flow data, and the at lease one member ID of the at lease one data supplier included in the total trading cash-flow data, clearing and calculating of the at least one profit is processed to obtain a profit-sharing result to grant a shared profit to the at least one data supplier related to the PD trading activity based on the profit-sharing result. Accordingly, a novel device for trading PD is obtained.

### BRIEF DESCRIPTION OF THE DRAWINGS

The present invention will be better understood from the following detailed description of the preferred embodiment according to the present invention, taken in conjunction with the accompanying drawing, in which

FIG. 1 is the view showing the preferred embodiment according to the present invention; and

FIG. 2 is the view showing the personal data (PD) trading.

### DESCRIPTION OF THE PREFERRED EMBODIMENT

The following description of the preferred embodiment is provided to understand the features and the structures of the present invention.

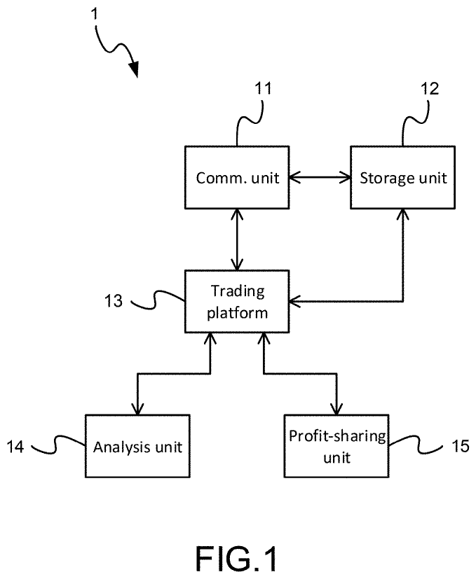

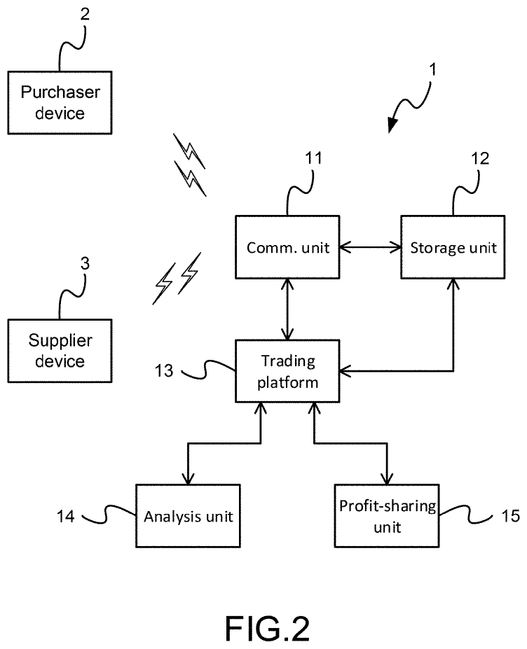

Please refer to FIG. 1 and FIG. 2, which are a view showing a preferred embodiment according to the present invention; and a view showing PD trading. As shown in the figures, the present invention is a device for trading PD 1, which trades PD by using networking devices for members. The networking devices for the members comprise purchaser devices 2 (e.g. smartphones or computers) for data purchasers and supplier devices 3 (e.g. smartphones or physiological measuring devices) for data suppliers. The device for trading PD 1 comprises a communication unit 11, a storage unit 12, a trading platform 13, an analysis unit 14, and a profit-sharing unit 15.

The communication unit 11 communicates to the data purchasers through the purchaser devices 2 to respond to PD requests uploaded by the data purchasers; and communicates to the data suppliers through the supplier devices 3 to receive PD uploaded by the data suppliers based on the PD requests. Therein, the PD request is obtained from a poll sheet, a market-research sheet, a PD sheet, a sheet of future and past personal physiological information, a habit/interest sheet, a personal-wish sheet, a credit-rating sheet, an academic-research sheet, or a sheet of a combination of any of the above.

The storage unit 12 connects to the communication device 11 to store the PD received from the communication unit 11.

The trading platform 13 connects to the communication device 13 and the storage unit 12. The trading platform 13 matches up the PD requests uploaded by the data purchasers with the PD stored in the storage unit 12 so as to obtain a matched trading result to be returned back to the data purchasers. On processing a PD trading activity on the trading platform 13 by the data purchaser, total trading cash-flow data are generated. The total trading cash-flow data comprise a turnover, a profit, and a member identification (ID) of the data purchaser related to the PD trading activity.

The analysis unit 14 connects to the trading platform 13, where status data of the data supplier are generated by analyzing the PD to be returned back to the data supplier.

The profit-sharing unit 15 connects to the trading platform 13. On processing the PD trading activity to earn a profit through the trading platform 13 based on a predetermined profit-sharing scheme, the total trading cash-flow data, and the member ID of the data supplier included in the total trading cash-flow data, clearing and calculating of the profit is processed to generate a profit-sharing result to grant a shared profit to the data supplier related to the PD trading activity based on the profit-sharing result. Thus, a novel device for trading PD is obtained.

On using, the device for trading PD 1 is practiced in a computer; the trading platform 13 is a central process unit (CPU) of the computer; the communication unit 11, the analysis unit 14, and the profit-sharing unit 15 are programs in the computer and are stored in a hard drive or a memory; the storage unit 12 is a hard drive; and, furthermore, there are a monitor, a mouse, and a keyboard for related outputs and operations. Nonetheless, the device for trading PD 1 can be practiced in a remote server.

In a state-of-use, the PD request uploaded by the purchaser device 2 is a sheet of future and past personal physiological information; and the supplier device 3 is a physiological measuring device. On using, the data supplier wears the supplier device with physiological measuring function to be connected to the communication device 11, where the communication device 11 is a cable network or a network using a wireless communication protocol and the wireless communication protocol can be 3G, 4G, 5G, wi-fi, etc. After connection is formed, related programs are logged in with the communication device 11 while a member is registered and the data of the member is stored in the storage unit 12.

On using, the data supplier obtains his physiological information (e.g. blood pressure, oxygen in blood, temperature, etc.) through measuring with the supplier device 3; and, then, the supplier device 3 connects to the communication device 11 to upload the personal physiological information provided by the data supplier through the communication device 11 to be stored in the storage unit 12. When the trading platform 13 matches up the sheet of future and past personal physiological information proposed by the data purchaser with the personal physiological information stored in the storage unit 12, a matched trading result is generated to be returned back to the data purchaser. On processing a PD trading activity on the trading platform 13 by the data purchaser, total trading cash-flow data are generated, which comprise a turnover, a profit, and a member ID of the data purchaser related to the PD trading activity. On processing the PD trading activity to earn profit through the trading platform with the profit-sharing unit 15 based on a predetermined profit-sharing scheme, the total trading cash-flow data, and the member ID of the data supplier included in the trading cash-flow data, clearing and calculating of the profit is processed to obtain a profit-sharing result. A shared profit, including a cash, an electronic cash, a virtual currency, a dividend, a consumer shopping cash, and/or a discount, is granted to the data supplier related to the PD trading activity based on the profit-sharing result. In the meantime, the analysis unit 14 processes related physiological analysis based on the personal physiological information of the data supplier, such as the cardiovascular health degree of the data supplier, to provide health indicators and return back the result of the analysis to the data supplier for reference.

The device for trading PD according to the present invention transfers the PD of the data provider to the trading platform. The data purchaser can obtain requested data further through the 3G, 4G, or 5G communication device at anytime and anywhere. In another word, as long as the data purchaser pays a required fee, the request PD is acquired. Thus, the data purchaser can make polls, market researches, and studies with the present invention. The data obtained include, but not limited to, personal information, future and past personal physiological information, habits/interests, academic-research sheets, personal wishes (e.g. wishful types of information that individuals choose to accept), and/or credit rating (e.g. credit rating generated through calculation to notify the data purchaser). Accordingly, not only the trading platform is established to help purchasers and suppliers in matchmaking PD demands and supplies; but also an analysis and profit-sharing mechanism is built for the data providers to voluntarily distribute PD to earn profit. The device can transfer an analysis result of the PD back to the data provider, and, when profit is earned with the device, the profit is further shared back to the data provider through the device. Hence, the PD can be managed just like personal assets for trading in markets of PD supplies and demands with contribution to market activities. The present invention helps accumulating uses and configurations of multivariate data for releasing the true value of big data as effectively promoting the revolution and progress of social policies and industries.

To sum up, the present invention is a device for trading PD, where not only the trading platform is established to help purchasers and suppliers in matchmaking PD demands and supplies, but also an analysis and profit-sharing mechanism is built for the data providers to voluntarily distribute PD to earn profit; and the device transfers an analysis result of the PD back to the data provider, and, when a profit is earned with the device, the profit is further shared back to the data provider through the device.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A device for trading personal data (PD), trading PD by using a plurality of networking devices comprising at least one supplier device provided to at least one data supplier and at least one purchaser device provided to at least one data purchaser, comprising
a communication unit, wherein said communication unit communicates to said at least one data purchaser through said at least one purchaser device to respond to at least one PD request uploaded by said at least one data purchaser; and said communication unit communicates to said at least one data supplier through said at least one supplier device to receive at lease one PD uploaded by said at least one data supplier based on said at least one PD request;
a storage unit, connecting to said communication unit to store said at lease one PD received from said communication unit;
a trading platform, connecting to said communication unit and said storage unit, wherein said trading platform matches up said at least one PD request uploaded by said at least one data purchaser with said at least one PD stored in said storage unit so as to obtain a matched trading result to be returned back to said at least one data purchaser; on processing said PD trading activity on said trading platform by said at least one data purchaser, total trading cash-flow data are obtained; and said total trading cash-flow data comprise at least one turnover, at least one profit, and at least one member identification (ID) of said at least one data purchaser related to said PD trading activity;
an analysis unit, connecting to said trading platform, wherein status data of said at least one data supplier are obtained by analyzing said PD to be returned back to said data supplier; and
a profit-sharing unit, connecting to said trading platform, wherein, on processing said PD trading activity to earn a profit through said trading platform based on a predetermined profit-sharing scheme, said total trading cash-flow data, and said at lease one member ID of said at lease one data supplier included in said total trading cash-flow data, clearing and calculating of said at least one profit is processed to obtain a profit-sharing result to grant a shared profit to said at least one data supplier related to said PD trading activity based on said profit-sharing result.

2. The device according to claim 1, wherein said shared profit is selected from a group consisting of a cash, an electronic cash, a virtual currency, a dividend, a consumer shopping cash, a discount, and a combination of any of the above.

3. The device according to claim 1, wherein said supplier device is selected from a group consisting of a smartphone, a physiological measuring device, a notebook, a personal computer (PC), a cloud server, a tablet, and a related device conforming to purchaser-designated specifications.

4. The device according to claim 1, wherein said supplier device is selected from a group consisting of a smartphone, a notebook, a PC, a tablet, a cloud server, and a device of browsing, storing, and analyzing conforming to purchaser's requirement.

5. The device according to claim 1, wherein said PD request is obtained from a sheet selected from a group consisting of a poll sheet, a market-research sheet, a PD sheet, a sheet of future and past personal physiological information, a habit/interest sheet, a personal-wish sheet, an academic-research sheet, and a credit-rating sheet, and a sheet of a combination of any of the above.

6. The device according to claim 1, wherein said communication unit is selected from a group consisting of a cable network and a network using wireless communication protocol.
